(19) United States
(12) Patent Application Publication
(10) Pub. No.: US 2009/0304863 A1
(43) Pub. Date: Dec. 10, 2009

(54) Flavor-improving agent, method of producing the same and food composition, acidic food composition, and acidic condiment containing the flavor-improving agent

(75) Inventors: Yohei Okuyama, Tokyo (JP); Akira Takeuchi, Tokyo (JP); Masaaki Kunou, Tokyo (JP); Mineo Hasegawa, Tokyo (JP); Kenji Watanabe, Tokyo (JP)

Correspondence Address: WOLF GREENFIELD & SACKS, P.C., 600 ATLANTIC AVENUE, BOSTON, MA, 02210-2206, US

(73) Assignee: Q.P. Corporation, Tokyo (JP)

(21) Appl. No.: 11/920,658

(22) PCT Filed: May 16, 2006
(86) PCT No.: PCT/JP2006/309736

§ 371 Date: Aug. 21, 2009

(30) Foreign Application Priority Data
May 20, 2005 (JP) 2005-148367

(51) Int. Cl. A23L 1/23; A23L 1/32

(52) U.S. Cl. 426/32; 426/533

(57) ABSTRACT

A flavor improving agent includes lactic acid-fermented egg white. A food composition, an acidic food composition, and an acidic condiment, which have a flavor improving effect, include lactic acid-fermented egg white. A method of producing a flavor improving agent includes adding lactic acid bacteria to an egg white aqueous solution and subjecting the mixture to fermentation.

### TECHNICAL FIELD

The present invention relates to a flavor improving agent, a method of producing the same, and a food composition, an acidic food composition, and an acidic condiment containing the flavor improving agent.

### BACKGROUND ART

Along with recent diversification of foodstuffs, the flavor of food is changed by adding a fermented food such as yoghurt as a hidden flavor to provide a flavor differing from that of the original food. However, since fermented food has a strong flavor, the flavor of the original food may be impaired due to the flavor of the fermented food. Therefore, it is difficult for a person without an outstanding cooking skill to utilize fermented food.

As known fermented foods, soy sauce and miso (soybean paste) have been familiar to Japanese. Fish sauce and sweet flour paste used in Asia are limited in terms of use due to a strong flavor. Since Western fermented food such as yoghurt is made from milk, such fermented food is suitable for a particular food, but is not suitable for other types of food. Therefore, it is difficult to widely utilize such fermented food. In view of such a situation, development of fermented food has been expected which has an excellent flavor and texture and improves the flavor of various types of food without impairing the basic flavor of the food.

### DISCLOSURE OF THE INVENTION

An object of the invention is to provide a flavor improving agent containing lactic acid-fermented egg white which has an excellent flavor and can improve the flavor of food by providing a rich and complex flavor without impairing the basic flavor of the food.

Another object of the invention is to provide a food composition, an acidic food composition, and an acidic condiment having an improved flavor due to incorporation of the flavor improving agent.

In order to achieve the above objects, the inventors of the invention have focused on egg white which has not been studied as a fermentation agent and conducted extensive studies on a flavor improving effect of lactic acid-fermented egg white. As a result, the inventors have found that the lactic acid-fermented egg white has an excellent flavor and can provide food with a rich and complex flavor without impairing the basic flavor of the food.

A flavor improver according to a first aspect of the invention comprises lactic acid-fermented egg white.

In the above flavor improving agent, the lactic acid-fermented egg white may be obtained by adding lactic acid bacteria to an aqueous solution containing egg white and a lactic acid bacteria-assimilating saccharide, and subjecting the mixture to fermentation.

A food composition having a flavor improving effect according to a second aspect of the invention comprises the above flavor improving agent.

An acidic food composition having a flavor improving effect according to a third aspect of the invention comprises the above flavor improving agent.

An acidic condiment having a flavor improving effect according to a fourth aspect of the invention comprises the above flavor improving agent.

A method of producing a flavor improving agent according to a fifth aspect of the invention comprises adding lactic acid bacteria to an aqueous solution containing egg white and a lactic acid bacteria-assimilating saccharide, and subjecting the mixture to fermentation.

The above method of producing a flavor improving agent may further comprise heating the aqueous solution before fermentation.

The above method of producing a flavor improving agent may further comprise homogenizing the fermented product.

In the above method of producing a flavor improving agent, the aqueous solution may further contain 0.05 to 5 mass % of egg yolk.

The above flavor improving agent has an excellent flavor and improves the flavor of food by providing a rich and complex flavor without impairing the basic flavor of the food.

A food composition, an acidic food composition, and an acidic condiment having an improved flavor can be obtained by adding the above flavor improving agent. For example, when putting an egg yolk type mayonnaise sauce on teriyaki chicken, the basic flavor of the teriyaki chicken may be reduced due to the taste of the egg yolk type mayonnaise sauce. On the other hand, when using a whole egg type mayonnaise sauce or a light-taste mayonnaise sauce using a large amount of starch, the flavor of the mayonnaise sauce may not be obtained due to lack of complexity in taste. Therefore, by adding the flavor improving agent containing the lactic acid-fermented egg white to such a light-taste mayonnaise sauce, the flavor of the mayonnaise sauce can be made rich without impairing the basic flavor of the teriyaki chicken. As a result, the flavor of the teriyaki chicken using the mayonnaise sauce can be improved.

### BEST MODE FOR CARRYING OUT THE INVENTION

A flavor improving agent according to one embodiment of the invention, a method of producing the same, and a food composition, an acidic food composition, and an acidic condiment containing the flavor improving agent are described below. In the invention, “%” indicates “mass %”.

### 1. FLAVOR IMPROVING AGENT AND METHOD OF PRODUCING THE SAME

### 1.1. Flavor Improving Agent

A flavor improving agent according to one embodiment of the invention comprises lactic acid-fermented egg white. Specifically, the lactic acid-fermented egg white can be used as the flavor improving agent. In the invention, the lactic acid-fermented egg white may be obtained by adding lactic acid bacteria to an aqueous solution containing egg white and a lactic acid bacteria-assimilating saccharide, and subjecting the mixture to fermentation.

The lactic acid-fermented egg white has an excellent flavor and improves the flavor of food by providing a rich and complex flavor without impairing the basic flavor of the food.

In the invention, the egg white is obtained by cracking an egg from a bird such as a hen, and removing the egg yolk, and includes industrially available egg white, egg white obtained by sterilizing, freezing, condensing, or diluting the industrially available egg white, a product obtained by removing specific components such as lysozyme and avidin, a product obtained by hydrating dried egg white, and the like. The egg white may contain egg yolk or other components of egg origin to such an extent the effects of the invention are not impaired.

In the invention, lactic acid fermentation refers to fermentation conducted in a state in which lactic acid bacteria is present in an amount of 10³ to 10⁸, and preferably 10⁵ to 10⁷ per ml. The lactic acid bacteria used for lactic acid fermentation is not particularly limited. Example of the lactic acid bacteria include lactic acid bacteria used to produce yoghurt and cheese, which belongs to the genus Lactobacillus (for example, Lactobacillus bulgaricus), genus Streptococcus (for example, Streptococcus thermophilus and Streptococcus diacetylactis), genus Lactococcus (for example, Lactococcus lactis), genus Leuconostoc (for example, Leuconostoc cremoris), genus Enterococcus (for example, Enterococcus faecalis), genus Bifidobacterium (for example, Bifidobacterium bifidum), and the like.

In the invention, the lactic acid-fermented egg white does not have an characteristic acidity, which fermented milk such as yoghurt has, and has an extremely mild flavor with little stimulation. Therefore, the lactic acid-fermented egg white may be added to various types of food without impairing the basic flavor of the food. It is considered that the lactic acid-fermented egg white added to food provides the food with a rich and complex flavor due to the overall effects of various fermented products made from the egg white.

The flavor improving agent according to this embodiment may have various forms (e.g. microcolloid, powder, cream, paste, or jelly). Specifically, the flavor improving agent can be obtained in various forms by appropriately processing the lactic acid-fermented egg white depending on the application.

For example, the lactic acid-fermented egg white may be obtained in the form of a microcolloid by adding lactic acid bacteria to an aqueous solution containing egg white and a lactic acid bacteria-assimilating saccharide, subjecting the mixture to fermentation, and homogenizing the resulting product (details are described later). The lactic acid-fermented egg white can be homogeneously dispersed in a food composition by producing a food composition or a pharmaceutical composition described later using the lactic acid-fermented egg white in the form of a microcolloid.

The lactic acid-fermented egg white may be obtained as a powder by drying (e.g. freeze drying, spray drying, or vacuum drying) the lactic acid-fermented egg white in the form of a microcolloid. The powdered lactic acid-fermented egg white is easy to handle due to its light weight. The lactic acid-fermented egg white can be homogeneously dispersed by adding the powdered lactic acid-fermented egg white to the food composition.

The flavor improving agent according to this embodiment may be used as a component of a food or the like, or may be directly used as a food or the like.

Specifically, the flavor improving agent according to this embodiment may be used as a component of a food composition, an acidic food composition, or an acidic condiment described later. Since the lactic acid-fermented egg white has little odor peculiar to an egg and a good texture and is delicious as mentioned above, the lactic acid-fermented egg white may be used as a component of a food composition, an acidic food composition, or an acidic condiment described later. Moreover, the lactic acid-fermented egg white rarely changes in properties due to heat, storage, and the like when added to processed food.

The food composition, the acidic food composition, or the acidic condiment for which the flavor improving agent according to this embodiment may be used is not particularly limited. When adding the flavor improving agent according to this embodiment to acidic food, the acidity can be reduced without impairing the basic flavor of the food.

### 1.2. Method of Producing Flavor Improving Agent

A method of producing a flavor improving agent according to one embodiment of the invention comprises adding lactic acid bacteria to an aqueous solution containing egg white and a lactic acid bacteria-assimilating saccharide, and subjecting the mixture to fermentation. Lactic acid-fermented egg white can be obtained by this step.

The lactic acid fermentation temperature is preferably 25 to 50° C., and more preferably an optimal culturing temperature of the lactic acid bacteria used. The degree of lactic acid fermentation is preferably 0.3 to 2% in terms of the lactic acidity at the completion of fermentation.

The fermentation efficiency can be improved by adding the lactic acid bacteria-assimilating saccharide when subjecting the egg white to lactic acid fermentation. As the lactic acid bacteria-assimilating saccharide, monosaccharides (e.g. glucose, galactose, fructose, mannose, or N-acetylglucosamine), disaccharides (lactose, maltose, sucrose, cellbiose, or trehalose), oligosaccharides (particularly an oligosaccharide in which 3 to 5 monosaccharides are bonded), and glucose fructose liquid sugar may be used either individually or in combination of two or more. The amount of lactic acid bacteria-assimilating saccharide added is preferably 1 to 15%, and more preferably 2 to 10% based on the aqueous solution. If the amount of lactic acid bacteria-assimilating saccharide is less than 1%, fermentation may not sufficiently proceed due to shortage of the lactic acid bacteria-assimilating saccharide. If the amount of lactic acid bacteria-assimilating saccharide exceeds 15%, fermentation may not sufficiently proceed due to an increase in osmotic pressure.

The aqueous solution containing the egg white and the lactic acid bacteria-assimilating saccharide may further contain egg yolk in an amount of 0.05 to 5 mass %, and preferably 0.5 to 2 mass %. If the content of egg yolk in the aqueous solution is 0.05 to 5 mass %, lactic acid fermentation can be further promoted. If the content of egg yolk exceeds 5 mass %, flavor may be impaired. If the content of egg yolk is less than 0.05 mass %, lactic acid fermentation may not be sufficiently promoted.

An additional fermentation-promoting substance may be added to the aqueous solution when carrying out lactic acid fermentation. As the fermentation-promoting substance, any substance containing a component for promoting fermentation such as a vitamin (e.g. nicotinic acid, pantothenic acid, or biotin), an amino acid, or a nucleic acid may be used without specific limitations. Examples of the fermentation-promoting substance include a yeast extract, meat extract, malt extract, casein hydrolyzate, vitamins, coenzymes, and minerals.

The method may further comprise heating the aqueous solution containing the egg white and the lactic acid bacteria-assimilating saccharide before fermentation. A microorganism growth-inhibiting factor (factor which inhibits growth and/or fermentation in lactic acid bacteria) can be deactivated by heating the aqueous solution.

The aqueous solution is preferably heated at a temperature of 60 to 110° C., and more preferably 70 to 95° C. If the temperature is less than 60° C., deactivation of the microorganism growth-inhibiting factor present in the egg white may be insufficient, leading to insufficient fermentation. If the temperature exceeds 110° C., thermal denaturation may progress to a large extent, making industrial application difficult due to browning or burning.

The egg white can be thermally denatured by heating the aqueous solution at a temperature of 60 to 110° C. for 1 to 60 minutes. The term “thermal denaturation of egg white” used herein refers to changing the properties of the egg white, such as causing the egg white to cohere or coagulate. The higher the temperature, the shorter the heating time may be. Thermal denaturation of the egg white has an effect of deactivating the lactic acid bacteria growth-inhibiting factor such as lysozyme to promote smooth lactic acid fermentation.

The method may further comprise homogenizing the fermented product. The term “homogenization” used in the invention refers to homogeneously dispersing components of a fermented product, obtained by subjecting the aqueous solution containing the egg white and the lactic acid bacteria-assimilating saccharide to lactic acid fermentation, by applying an external physical force.

Examples of the method of applying an external physical force include straining using a strainer, stirring using a pump, pressurization using a high-pressure homogenizer, and the like, although the method is not specifically limited. In particular, pressurization/crushing using a high-pressure homogenizer is preferred from the industrial point of view. The pressure applied is preferably 10 to 80 MPa, and more preferably 30 to 60 MPa.

The average particle size of the lactic acid-fermented egg white obtained by homogenization is preferably 30 micrometers or less, and more preferably 15 micrometers or less. If the average particle size is 30 micrometers or less, the lactic acid-fermented egg white can be homogeneously dispersed in a food composition, and a product with a smooth texture can be prepared.

A typical method of producing a flavor improving agent according to this embodiment is given below. After the addition of 2 to 8% of an egg white protein, 1 to 15% of a lactic acid bacteria-assimilating saccharide, and 0.5 to 10% of a fermentation-promoting substance to water, the pH of the mixture is adjusted to 5 to 7.5 using lactic acid. After heating the resulting solution at 60 to 110° C. for 1 to 10 minutes, a lactic acid bacteria starter containing Lactobacillus bulgaricus and Streptococcus thermophilus is added to the solution in an amount of 10⁵ to 10⁷ per ml, followed by fermentation at 25 to 50° C. for 8 to 48 hours. After completion of fermentation, the fermented product is homogenized under high pressure. Specifically, the fermented product is homogenized under a pressure of 10 to 80 MPa to obtain a lactic acid-fermented egg white in the form of a microcolloid.

### 1.3. Comparison Between Related-Art Technology and Flavor Improving Agent According to this Embodiment

Foods Produced by Fermenting an Egg are Disclosed in Jp-A-9-191863, JP-A-2-234655, JP-A-9-103239, JP-A-57-54113, JP-A-52-15693, and JP-A-53-9353. However, these documents do not describe that the flavor of food can be improved by adding a fermented egg.

In order to demonstrate that the foods disclosed in these documents do not aim at improving flavor, tests were conducted in accordance with the examples of JP-A-9-191863, JP-A-9-103239, JP-A-52-15693, and JP-A-53-9353. As a result of the tests, a fermented product with a good flavor could not be obtained. This is considered to be because the flavor deteriorated due to a large amount of egg yolk used as the fermentation agent.

Since JP-A-2-234655 and JP-A-57-54113 do not employ homogenization, texture may be impaired. It is considered that JP-A-2-234655 and JP-A-57-54113 do not aim at providing a flavor improving agent.

### 2. FOOD COMPOSITION

A food composition having a flavor improving effect according to one embodiment of the invention (hereinafter may be simply called “food composition”) comprises the above flavor improving agent. Specifically, the food composition according to this embodiment comprises lactic acid-fermented egg white. The form of the lactic acid-fermented egg white added to the food composition according to this embodiment may be appropriately selected depending on the application. As examples of the food composition according to this embodiment, a food composition, an acidic food composition, and an acidic condiment can be given. The content of the flavor improving agent in the food composition is preferably 1 mass % or more, and more preferably 20 to 70 mass %. In particular, the content of the flavor improving agent in the acidic condiment is preferably 3 to 50 mass %.

The food composition according to this embodiment may be processed food, for example. Examples of the processed food include confectionery, processed products of rice or beans, condiment, dairy products (e.g. milk beverages, fermented milk, lactic acid bacteria beverages, and dairy lactic acid bacteria beverages), processed egg products, cooked food, beverages (e.g. soft drink), dessert, nutritious food such as liquid food, medical diet, and the like.

The term “acidic food” used in the invention refers to food provided with improved storage stability by inhibiting the growth of microorganisms by adjusting the pH to about 4 or less. Food can be distributed and stored at room temperature by acidifying the food without providing a high-temperature high-pressure heat treatment such as retorting, whereby a change in flavor and texture of the food can be minimized. Examples of such food include jam, fruit jellies and the like, dessert, beverages (e.g. soft drink), condiment, cooked food using vinegar or tomato sauce, and the like.

The term “acidic condiment” used in the invention refers to condiment food added to a dish in order to impart a flavor and provide a variation. Examples of the acidic condiment include mayonnaise, dressing, liquid condiment such as ponzu sauce (juice pressed from a bitter orange) and sauce, and powdered condiment prepared by drying and powdering the above condiment. The acidic condiment may or may not contain oils and fats.

### 3. EXAMPLE

The invention is described below in more detail by way of examples and test examples. Note that the invention is not limited to the following examples. The particle size of particles in microcolloidal lactic acid-fermented egg white was determined by the following method.

Measuring method: The particle size and the particle size distribution were analyzed from the light intensity distribution pattern of diffracted/scattered light when applying laser light to the particles.
Measuring instrument: Shimadzu laser diffraction particle size distribution analyzer “SALD-200V” (manufactured by Shimadzu Corporation)

### 3.1. Example 1

3 kg of an egg white aqueous solution containing 34% of liquid egg white, 6% of sucrose, 0.5% of egg yolk, 0.05% of a yeast extract, 0.15% of 50% lactic acid, and 59.3% of water was prepared with stirring. After heating the resulting egg white aqueous solution at 75° C. for 10 minutes, 0.01% of a lactic acid bacteria starter (Lactobacillus bulgaricus and Streptococcus thermophilus) was added. The mixture was subjected fermentation at 42° C. for 24 hours, followed by pasteurization at 70 to 90° C. to obtain a fermented product having a pH of 4.2 and containing a yoghurt-like flavor component. The lactic acidity of the fermented product was 0.7%. The fermented product was pressurized and crushed under a pressure of 30 MPa using a high-pressure homogenizer to obtain a microcolloidal lactic acid-fermented egg white with an average particle size of 0.1 to 2.0 micrometers.

### 3.2. Example 2

3 kg of an egg white aqueous solution containing 50% of liquid egg white, 9% of glucose fructose liquid sugar, 0.05% of a yeast extract, 0.5% of powdered skim milk, 0.15% of 50% lactic acid, and 40.3% of water was prepared with stirring. After heating the resulting egg white aqueous solution at 75° C. for 10 minutes, 0.01% of a Lactobacillus starter (Lactococcus lactis subsp. lactis, Leuconostoc mesenteroides subsp. cremoris, Streptococcus diacetylactis, and Lactococcus lactis subsp. cremoris) was added. The mixture was subjected fermentation at 30° C. for 24 hours, followed by pasteurization at 70 to 90° C. to obtain a fermented product having a pH of 4.3 and containing a sour cream-like flavor component. The lactic acidity of the fermented product was 0.6%. The fermented product was pressurized and crushed under a pressure of 50 MPa using a high-pressure homogenizer to obtain a microcolloidal lactic acid-fermented egg white with an average particle size of 0.1 to 2.0 micrometers.

### 4. APPLICATION EXAMPLE

Application examples are give below in which the lactic acid-fermented egg white obtained in Example 1 was added to various food compositions.

### 4.1. Application Example 1

A mayonnaise-like condiment containing the lactic acid-fermented egg white obtained in Example 1 was prepared according to the following formulation.

| | | |
|---|---|---|
| Egg yolk | 142 | g |
| Rapeseed oil | 705 | g |
| Vinegar (acidity: 9%*) | 64 | g |
| Salt | 18 | g |
| Sodium glutamate | 4 | g |
| Mustard powder | 3 | g |
| Lactic acid-fermented egg white | 64 | g |

*The acidity is based on acetic acid.

1000 g of a mayonnaise-like acidic condiment was prepared by a known method using a household mixer according to the above formulation, and provided in a tube (200 g). The resulting mayonnaise-like acidic condiment had a pH of 4.05 and a viscosity of 380 Pa·s (25° C.).

A comparative example product was prepared according to the above formulation except for using egg white instead of the lactic acid-fermented egg white. A fried white meat fish was dipped into the condiment and tasted. The condiment of Application Example 1 using the product according to the invention had a flavor milder than that of the comparative example and had a complex taste, thereby improving the flavor of the fried white meat fish.

### 4.2. Application Example 2

A sour cream-flavored dressing containing the lactic acid-fermented egg white obtained in Example 1 was prepared according to the following formulation.

| | | |
|---|---|---|
| Rapeseed oil | 400 | g |
| Lactic acid-fermented egg white | 250 | g |
| Vinegar (acidity: 4.2%*) | 90 | g |
| Salt | 20 | g |
| Glucose fructose liquid sugar | 20 | g |
| Fresh cream | 20 | g |
| Lemon juice | 5 | g |
| Spice | 2 | g |
| Xanthan gum (thickener) | 2 | g |

*The acidity is based on acetic acid.

Freshwater was added to the above components to adjust the total mass to 1000 g.

A sour cream-flavored dressing was prepared by a known method using a household mixer according to the above formulation, and hot-packed in a glass bottle (150 g). The resulting sour cream-flavored dressing had a pH of 3.95.

A comparative example product was prepared according to the above formulation except for using yoghurt (dairy product) instead of the lactic acid-fermented egg white. A cold vegetable salad was dipped into the dressing and tasted. The dressing of Application Example 2 using the product according to the invention had a reduced acidity and a mild flavor as compared with the comparative example and had a complex aftertaste, thereby improving the flavor of the cold vegetable salad.

### 4.3. Application Example 3

A yoghurt-flavored soft drink containing the lactic acid-fermented egg white obtained in Example 1 was prepared according to the following formulation.

| | |
|---|---|
| Lactic acid-fermented egg white | 270 g |
| Glucose fructose liquid sugar | 130 g |
| Citric acid | 3 g |
| Sodium citrate | 1 g |
| Lemon juice | 5 g |
| Soybean dietary fiber | 5 g |
| Pectin (thickener) | 3 g |
| Glyceride | 8 g |
| Yoghurt flavor | 2 g |

Freshwater was added to the above components to adjust the total mass to 1000 g.

A yoghurt-flavored soft drink was prepared by a known method using a household mixer according to the above formulation, hot-packed in an aluminum can (350 g), and the can was seam-sealed. The resulting yoghurt-flavored soft drink had a pH of 3.7 (25° C.).

A comparative example product was prepared according to the above formulation except for using yoghurt (dairy product) instead of the lactic acid-fermented egg white. The yoghurt-flavored soft drink was cooled to 10° C. and tasted. The yoghurt-flavored soft drink of Application Example 3 using the product according to the invention had a reduced acidity and a mild taste as compared with the comparative example and was rich in flavor.

### 4.4. Application Example 4

A yoghurt-flavored dessert jelly containing the lactic acid-fermented egg white obtained in Example 1 was prepared according to the following formulation.

| | | |
|---|---|---|
| Lactic acid-fermented egg white | 100 | g |
| Lemon juice | 60 | g |
| Fresh cream | 50 | g |
| Glucose fructose liquid sugar | 20 | g |
| Fructooligosaccharide | 20 | g |
| Crystalline cellulose | 5 | g |
| Sucrose fatty acid ester | 5 | g |
| Carrageenan (gelling agent) | 15 | g |
| Suclarose (sweetener) | 1 | g |
| Citric acid | 10 | g |
| Yoghurt flavor | 5 | g |

Freshwater was added to the above components to adjust the total mass to 1000 g.

A yoghurt-flavored dessert jelly was prepared by a known method using a household mixer according to the above formulation, hot-packed in a jelly cup (80 g). After hermetically sealing the jelly cup, the yoghurt-flavored dessert jelly was heated to 95° C. and cooled to 5° C. in a refrigerator. The resulting yoghurt-flavored dessert jelly had a pH of 3.75 (25° C.).

A comparative example product was prepared according to the above formulation except for using yoghurt (dairy product) instead of the lactic acid-fermented egg white. The yoghurt-flavored dessert jelly was cooled to 10° C. and tasted. The yoghurt-flavored dessert jelly of Application Example 4 using the product according to the invention had a reduced acidity and a mild taste as compared with the comparative example and was rich in flavor.

### 4.5. Application Example 5

An almond jelly-like chilled dessert containing the lactic acid-fermented egg white obtained in Example 1 was prepared according to the following formulation.

| | |
|---|---|
| Apricot kernel powder | 90 g |
| Agar | 4 g |
| Milk | 80 g |
| Lactic acid-fermented egg white | 80 g |
| Sugar | 52 g |
| Almond flavor | 3 g |

Freshwater was added to the above components to adjust the total mass to 1000 g.

An almond jelly-like chilled dessert was prepared by a known method using a household mixer according to the above formulation, hot-packed in a plastic tray (100 g). After hermetically sealing the plastic tray, the almond jelly-like chilled dessert was heated to 95° C. and cooled to 5° C. in a refrigerator. The resulting almond jelly-like chilled dessert had a pH of 5.75 (25° C.).

A comparative example product was prepared according to the above formulation except for using yoghurt (dairy product) instead of the lactic acid-fermented egg white. The almond jelly-like chilled dessert was cooled to 10° C. and tasted. The almond jelly-like chilled dessert of Application Example 5 using the product according to the invention had a reduced acidity and a mild taste as compared with the comparative example and was rich in flavor.

### 4.6. Application Example 6

An egg spread containing the lactic acid-fermented egg white prepared in Example 1 was prepared according to the following formulation.

| | | |
|---|---|---|
| Lactic acid-fermented egg white | 110 | g |
| Mayonnaise | 110 | g |
| Boiled egg | 760 | g |
| Salt | 2 | g |
| Cold water swelling starch | 2 | g |
| Bacteriostatic agent | 8 | g |
| Freshwater | 8 | g |

The basic ingredients were added to the crushed boiled egg according to the above formulation (total mass: 1000 g).

A heat-resistant nylon polypropylene bag was charged with the resulting product (500 g). The product was heated to 70° C. and cooled in a refrigerator. The resulting egg spread had a pH of 6.25 (25° C.).

A comparative example product was prepared according to the above formulation except for using mayonnaise instead of the lactic acid-fermented egg white. A sandwich was prepared using slices of bread and tasted. The egg spread of Application Example 6 using the product according to the invention had a reduced acidity and a mild flavor as compared with the comparative example and had an improved flavor of the boiled egg and a rich aftertaste.

1. A flavor improving agent comprising lactic acid-fermented egg white.

2. The flavor improving agent according to claim 1,
wherein the lactic acid-fermented egg white is obtained by adding lactic acid bacteria to an aqueous solution containing egg white and a lactic acid bacteria-assimilating saccharide, and subjecting the mixture to fermentation.

3. A food composition comprising the flavor improving agent according to claim 1.

4. An acidic food composition comprising the flavor improving agent according to claim 1.

5. An acidic condiment comprising the flavor improving agent according to claim 1.

6. A method of producing a flavor improving agent comprising adding lactic acid bacteria to an aqueous solution containing egg white and a lactic acid bacteria-assimilating saccharide, and subjecting the mixture to fermentation.

7. The method according to claim 6, further comprising heating the aqueous solution before fermentation.

8. The method according to claim 6, further comprising homogenizing the fermented product.

9. The method according to claim 6, wherein the aqueous solution further contains 0.05 to 5 mass % of egg yolk.

10. A food composition comprising the flavor improving agent according to claim 2.

11. An acidic food composition comprising the flavor improving agent according to claim 2.

12. An acidic condiment comprising the flavor improving agent according to claim 2.

13. The method according to claim 7, further comprising homogenizing the fermented product.

14. The method according to claim 7, wherein the aqueous solution further contains 0.05 to 5 mass % of egg yolk.

15. The method according to claim 8, wherein the aqueous solution further contains 0.05 to 5 mass % of egg yolk.

16. The method according to claim 13, wherein the aqueous solution further contains 0.05 to 5 mass % of egg yolk.
